(19) United States
(12) Patent Application Publication
(10) Pub. No.: US 2020/0033668 A1
(43) Pub. Date: Jan. 30, 2020

(54) DISPLAY PANEL, AND PROCESS FOR MANUFACTURING DISPLAY PANEL

(71) Applicants: HKC CORPORATION LIMITED, Shenzhen (CN); CHONGQING HKC OPTOELECTRONICS TECHNOLOGY CO.,LTD., CHONGQING (CN)

(72) Inventor: CHUNG-KUANG CHIEN, CHONGQING (CN)

(21) Appl. No.: 16/496,513

(22) PCT Filed: May 26, 2017
(86) PCT No.: PCT/CN2017/086143

§ 371 Date: Sep. 23, 2019

(30) Foreign Application Priority Data
Mar. 24, 2017 (CN) 201710185944.4

(51) Int. Cl. G02F 1/1335

(52) U.S. Cl. CPC G02F 1/133514

(57) ABSTRACT

A display panel and a manufacturing method thereof are provided. The manufacturing method includes steps of: doping at least three kinds of dye molecules into a colloid used to manufacture a photoresist body; applying the colloid on a substrate to form the photoresist; and irradiating the photoresist body with at least three lights each having different wavelength to control the dye molecules so as to form a color filter layers having at least three colors under the radiation of the light each having different wavelength. Wherein, the color filter includes a red filter, a green filter, and a blue filter.

### CROSS-REFERENCE TO RELATED APPLICATION

This application is a national application of PCT-application PCT/CN2017/086143 filed on May 26, 2017, which claims priority of the Chinese application CN 201710185944.4 filed on Mar. 24, 2017, both of which are incorporated herein by reference.

### BACKGROUND

### 1. Field

The disclosure relates to the display panel technology, especially relates to a display panel and a manufacturing method thereof.

### 2. Description of the Related Art

Because of numerous advantages such as thinner physical body, higher energy efficiency, lower radiation emission, etc., a liquid-crystal display (LCD) becomes a mainstream product being broadly used in various kinds of coatings. Most of liquid-crystal displays are a backlit type liquid-crystal display, which includes a liquid-crystal panel and a backlight module. The working principle of a liquid-crystal panel is the orientation control of liquid crystal molecules located between two parallel glass substrates through applying a driving voltage on these substrates, thereby refracting the light generated by the backlight module to form images.

Among liquid-crystal displays, thin film transistor-liquid crystal display or TFT-LCD is becoming prominent in display industry because of its lower power consumption, excellent image quality, and better production yield. Likewise, a thin film transistor-liquid crystal display includes a liquid-crystal panel and a backlight module, and the liquid-crystal panel includes a color filter substrate (CF substrate) and a thin film transistor substrate (TFT substrate), and there is a transparent electrode at the relative inner sides of the aforementioned substrates. There is a liquid crystal (LC) layer sandwiched by these two substrates. For the liquid-crystal panel, an electric field is used to control the orientation of the liquid crystal molecules, thereby changing the state of light polarization, and a polarizer is used to allow the light to pass through or to block it, thereby fulfilling the display purpose.

In the current manufacturing method of a liquid crystal panel, the manufacturing method of color filter substrate, for example, requires multiple photoresist coatings, multiple exposures, and multiple developments to form a color filter layer (e.g. R/G/B filter), a light-shading layer (e.g. black matrix (BM) layer), a spacer layer (e.g. photo spacer photoresist), etc., such that the final color filter substrate is formed. Wherein, the color filter layer manufacturing method usually requires three-time photoresist coatings, three-time exposures, and three-time developments. The manufacturing process is complicated.

### SUMMARY

According to one aspect of the disclosure, the disclosure discloses provides a manufacturing method of a display panel including, a substrate. The manufacturing method includes steps of: doping at least three kinds of dye molecules into a colloid used to manufacture a photoresist body, applying the colloid on the substrate to form the photoresist body, irradiating the photoresist body with three lights each having different wavelengths to control the dye molecules so as to form a color filter layer having at least three different colors under the radiation of the lights each having different wavelength, and removing the photoresist body that does not become the color filter layer at the same time.

The photoresist body is irradiated with the light having the first-wavelength to control the dye molecules, so as to form a red filter under the radiation of the light having the first-wavelength. The photoresist body is irradiated with the light having the second-wavelength to control the dye molecules so as to form a green filter under the radiation of the light having the second-wavelength. The photoresist body is irradiated with the light having the third-wavelength to control the dye molecules so as to form a blue filter under the radiation of the light having the third-wavelength.

The step of irradiating the photoresist body with the light having the first-wavelength to control the dye molecules so as to form the red filter under the radiation of the first-wavelength light includes: the light having the first-wavelength passing through a first mask and irradiating a red region of the photoresist body to control the dye molecules so as to form the red filter under the radiation of the light having the first-wavelength. The step of irradiating the photoresist body with the light having the second-wavelength to control the dye molecules so as to form the green filter under the radiation of the light having the second-wavelength includes: the light having the second-wavelength passing through a second mask and irradiating a green region of the photoresist body to control the dye molecules so as to form the green filter under the radiation of the light having the second-wavelength. The step of irradiating the photoresist body with the light having the third-wavelength to control the dye molecules so as to form the green filter under the radiation of the light having the third-wavelength includes: the light having the third-wavelength passing through a third mask and irradiation a blue region of the photoresist body to control the dye molecules so as to form the blue filter under the radiation of the light having the third-wavelength.

The color filter layer further comprises a W filter; the step of irradiating the photoresist body with at least three lights each having different wavelength to control the dye molecules so as to form the color filter layer having at least three different colors under the radiation of the lights each having different wavelengths further includes: irradiating the photoresist body with a light having the fourth-wavelength to control the dye molecules so as to form a white filter under the radiation of the light having the fourth-wavelength. The step of irradiating the photoresist body with the light having the fourth-wavelength to control the dye molecules so as to form the white filter under the radiation of the light having the fourth-wavelength further includes: the light having the fourth-wavelength passing through a fourth mask and irradiating a white region of the photoresist body to control the dye molecules so as to form the white filter under the radiation of the light having the fourth-wavelength.

According to other aspect of the disclosure, the disclosure provides a manufacturing method of a display panel including a substrate. The manufacturing method includes steps of: doping at least three kinds of dye molecules into a colloid used to manufacture a photoresist body, applying the colloid on the substrate to form the photoresist body, and irradiating the photoresist body with at least three lights each having different wavelength to control the dye molecules so as to form a color filter layer having at least three colors under the radiation of the lights each having different wavelength.

According to another aspect of the disclosure, the disclosure provides a display panel including a substrate and a color filter layer disposed on the substrate. Wherein, at least three different kinds of dye molecules that work in conjunction with at least three corresponding lights each having different wavelength so as to form the color filter layer having at least three different colors are disposed in the color filter layer, and the color filter layer includes a red filter, a green filter, and a blue filter.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure. It is obvious that the drawings in the following description are only some embodiments of the disclosure, and those ordinarily skilled in the art may obtain other drawings according to these without any inventive work. In the drawings:

FIG. 1 is a flow chart showing a manufacturing method of a display panel in an embodiment of the disclosure;

FIG. 2 is a flow chart showing a manufacturing method of a display panel in an embodiment of the disclosure;

FIG. 3 is a flow chart showing a partial manufacturing method of a display panel in an embodiment of the disclosure;

FIG. 4 is a structure schematic diagram showing a display panel in an embodiment of the disclosure.

### DESCRIPTION OF THE PREFERRED EMBODIMENTS

The specific structures and function details disclosed herein are only representative, and the purpose thereof is to illustrate the exemplary embodiments of the disclosure. The disclosure however may be embodied in many alternative forms and should not be construed as being limited to the embodiments set forth herein.

In the description of the disclosure, it is understood that the directional or positioning terms such as “center”, “horizontal”, “upper”, “lower”, “left”, “right”, “vertical”, “level”, “top”, “bottom”, “inside”, “outside”, etc. are based on the positions or positional relationship shown in the drawings, and the purpose is to facilitate the description of the disclosure and to simplify description, but not to indicate or to imply that the devices or elements are limited to specific directions or positions, or constructed or operated in specific orientations, and therefore these terms cannot be construed as limiting the disclosure. In addition, the terms “first”, “second”, etc. are for illustrative purposes only and are not to be construed as indicating or imposing a relative importance, or implying or indicating the number of technical features. For the technical features described by “first”, “second”, etc., the present application should be construed as expressly or implicitly including one or more of such features. In the description of the disclosure, “many” or “a plurality of” is to indicate two or more unless otherwise defined. In addition, the term “include” and any variants thereof are intended to mean non-exclusive inclusion.

In the description of the disclosure, it should be understood that, unless specified or limited otherwise, the terms “mounted”, “connected”, “coupled”, and variations thereof are to broadly express such as fixedly coupled, detachably coupled, or formed as a single element, and encompass such as mechanical or electrical couplings, and also can be inner couplings of two components, direct couplings, or indirect couplings through intermediaries. A person with ordinary skill can understand the meanings of the aforementioned terms in the disclosure based on particular situations.

The terms used herein are to illustrate but not to limit the exemplary embodiments of the present application. Unless specifically specified in the context, the singular forms “a” and “an” are intended to include the plural forms. It should also be understood that the terms “comprise” and/or “include” used herein is to specify the presence of stated features, integers, steps, operations, elements, and/or components, but not to preclude the presence or addition of one or more other features, integers, steps, operations, elements, components, and/or groups.

Similar constituent elements are designated by similar reference numerals throughout the drawings.

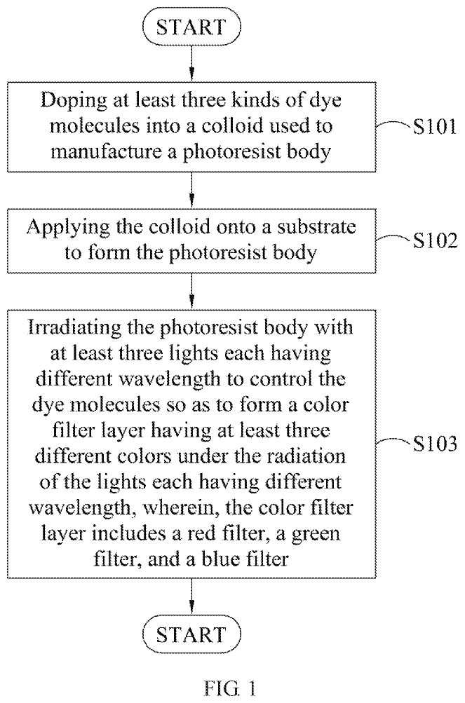

The following refers to FIGS. 1-4 and the preferred embodiments to further details the display panel and the manufacturing method thereof of the disclosure.

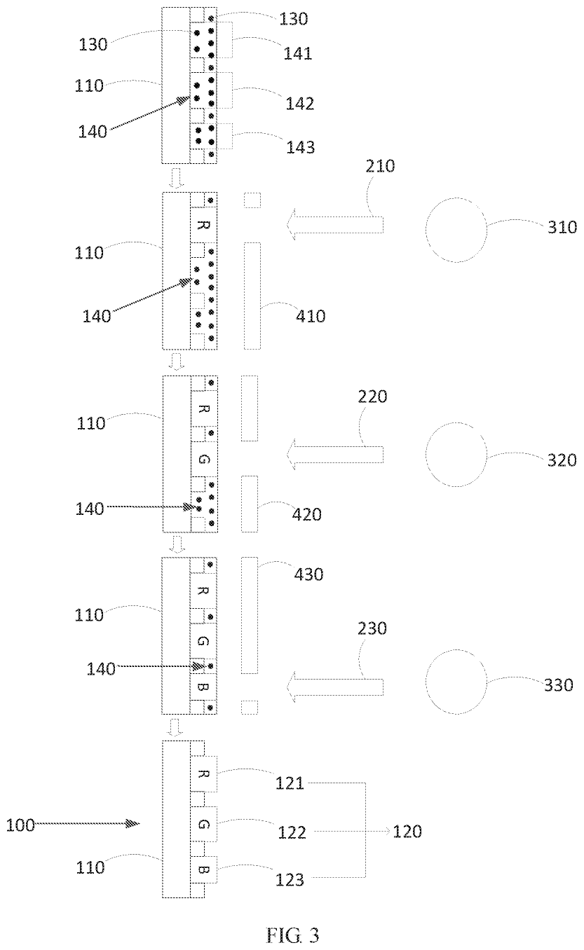

According to an embodiment of the disclosure as shown in FIG. 1 and FIG. 3, the disclosure provides a manufacturing method of a display panel. Wherein, the FIG. 1 is a flow chart showing the manufacturing method of the display panel of the embodiment, and FIG. 3 is a flow chart showing a partial manufacturing method of the embodiment. In the embodiment, the manufacturing method of the display panel includes step S101, step S102, and step S103. The details are as follows:

Step S101: doping at least three kinds of dye molecules 130 into a colloid used to manufacture a photoresist body 140.
Step S102: applying the colloid onto a substrate 110 to form the photoresist body 140.
Step S103: irradiating the photoresist body 140 with at least three lights each having different wavelength to control the dye molecules 130 so as to form a color filter layer 120 having at least three different colors under the radiation of the lights each having different wavelength. Wherein, the color filter layer 120 includes a red filter 121, a green filter 122, and a blue filter 123.

In step S101, the dye molecules are main components to the showing colors of the red filter 121, the green filter 122, and the blue filter 123. Because the dye molecules are characterized by their smaller molecular size and wider color range, the photoresist body 140 doped with dye molecules can form the red filter 121, the green filter 122, and the blue filter 123 when irradiated with three lights each having different wavelength. It is certain that the dye molecules can also be the main components to the showing colors of other filters such as a W filter, a Y filter, etc.

There are many choices of dye molecules such as ferric oxide for red.

In step S102, the colloid is applied once on the substrate 110 to form the photoresist body 140. In comparison with the current technology that requires three-time coatings of the colloid, the embodiment simplifies the manufacturing process, thereby improving the efficiency.

In step S103, at least three lights each having different wavelength irradiate the photoresist body 140 to control the dye molecules 130 so as to form the color filter layer 120 having at least three different colors under the radiation of the lights each having different wavelength. Wherein, the color filter layer 120 includes the red filter 121, the green filter 122, and the blue filter 123.

The embodiment uses three light sources to generate three lights each having different wavelength, wherein the first-light source 310 generates the light having the first-wavelength 210, the second-light source 320 generates the light having the second-wavelength 220, and the third-light source 330 generates the light having the third-wavelength 230.

Specifically, the photoresist body 140 is irradiated with the light having the first-wavelength 210 to control the dye molecules 130 so as to form the red filter 121 under the radiation of the light having the first-wavelength 210. The photoresist body 140 is irradiated with the light having the second-wavelength 220 to control the dye molecules 130 so as to form the green filter 122 under the radiation of the light having the second-wavelength 220. The photoresist body 140 is irradiated with the light having the third-wavelength 230 to control the dye molecules 130 so as to form the blue filter 123 under the radiation of the light having the third-wavelength 230. This is the specific method of the embodiment, where three lights each having different wavelength correspondingly work in conjunction with three different masks to respectively irradiate the photoresist body 140 to form the color filter 120 having three different colors.

More specifically, the light having the first-wavelength 210 passes through the first mask 410 and then irradiates a red region 141 of the photoresist body 140 to control the dye molecules 130 so as to form the red filter 121 under the radiation of the light having the first-wavelength 210. The light having the second-wavelength 220 passes through the second mask 420 and then irradiates a green region 142 of the photoresist body 140 to control the dye molecules 130 so as to form the green filter 122 under the radiation of the light having the second-wavelength 220. The light having the third-wavelength 230 passes through the third mask 430 and then irradiates a blue region 143 of the photoresist body 140 to control the dye molecules 130 so as to form the blue filter 123 under the radiation of the light having the third-wavelength 230.

It is noted that other procedures can also be included, for example:

a light having the fourth-wavelength irradiates the photoresist body 140 to control the dye molecules 130 so as to form a W filter under the radiation of the light having the fourth-wavelength. Specifically, the light having the fourth-wavelength passes through the fourth mask and then irradiates a white region of the photoresist body 140 to control the dye molecules 130 so as to form the W filter under the radiation of the light having the fourth-wavelength.

In summary, in the manufacturing method of the display panel of the embodiment, the dye molecules 130 are disposed in the colloid of the photoresist body 140 in this embodiment of the disclosure, and working in conjunction with each corresponding one of the lights each having different wavelengths. The dye molecules 130 make up the color filter layer 120 having different colors in the photoresist body 140 under the radiation of the lights each having different wavelength, wherein the color filter layer 120 includes the red filter 121, the green filter 122, and the blue filter 123. Therefore, through the dye molecules 130 disposed in the colloid of the photoresist body 140 in the embodiment of the disclosure, the manufacturing method disclosure of the display panel in the embodiment of the present application is: firstly, applying the colloid doped with dye molecules 130 on the substrate to form the photoresist body 140. After that, respectively irradiating the formed photoresist body 140 with three lights each having different wavelength, which causes the dye molecules 130 so as to form the color filter layer 120 having at least three different colors within the photoresist body 140. In comparison with the current technology that requires three-time coatings of the photoresist, the manufacturing method can complete it with one application, thereby shortening and simplifying the manufacturing process required, and therefore improving the efficiency.

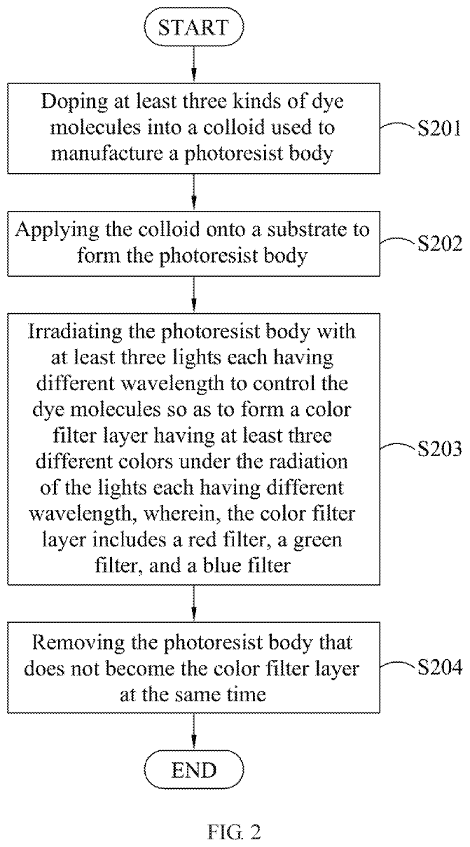

As shown in FIG. 2, which is a flow chart showing another manufacturing method of a display panel in an embodiment, together with FIG. 3, the manufacturing method of the display panel in the embodiment of the disclosure includes step S201, step S202, step S203, and step S204. Wherein, step S201, step S202, step S203, and step S204 are respectively the same as step S101, step S102, and step S103 in FIG. 1, and one can refer to step S101, step S102, and step S103 in FIG. 1 for step S201, step S202, and step S203 in FIG. 2, and therefore the redundancy is abstained here.

Specifically, step S204 is: removing the photoresist body 140 that does not become the color filter layer 120 at the same time.

In step S204, removing the photoresist body 140 that does not become the color filter layer 120 at the same time is a preferred choice for the manufacturing method of the display panel in the embodiment. Wherein, in comparison with three-time developments in the current technology, removing the photoresist body 140 that does not become the color filter layer 120 at the same time, that is forming the color filter layer 120 with only one development, in the embodiment further simplifies the manufacturing process required, thereby further improving the efficiency.

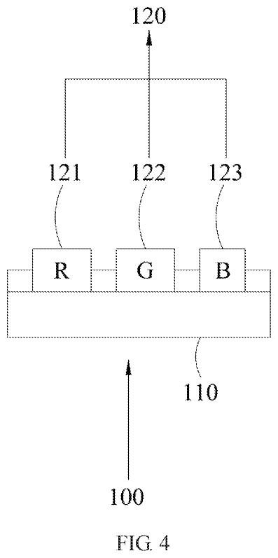

As shown in FIG. 4, which is a structure schematic diagram showing a display panel of an embodiment of the disclosure, together with FIGS. 1-3, the structure of the display panel 100 is formed by the manufacturing method of the display panel in FIG. 3, or can also be formed by the manufacturing method in FIG. 1 or FIG. 2. Specifically, the display panel 100 in an embodiment of the disclosure includes a substrate 110 and a color filter layer 120 disposed on the substrate 110. There are at least three different kinds of dye molecules 130 that respectively work in conjunction with at least three lights each having different wavelength so as to form the color filter layer 120 having at least three different colors disposed in the color filter layer 120. Wherein, the color filter layer 120 includes a red filter 121, a green filter 122, and a blue filter 123.

Wherein, the dye molecules 130 are main components to the showing colors of the red filter 121, the green filter 122, and the blue filter 123. Because the dye molecules are characterized by their smaller molecular size and wider color range, the photoresist body 140 doped with dye molecules can form the red filter 121, the green filter 122, and the blue filter 123 when irradiated with three lights each having different wavelength. It is certain that the dye molecules can also be the main components to the showing colors of other filters such as a W filter, a Y filter, etc.

This can simplify a display panel manufacturing process, thereby improving its efficiency.

Wherein, the display panel in the embodiments of the disclosure can be selected from the group consisting of: Twisted Nematic (TN) type, Super Twisted Nematic (STN) type, In-Plane Switching (IPS) type, Vertical Alignment (VA) type, High Vertical Alignment (HVA) type, or curved type display panel.

The display panels in the embodiments can be implemented in a display device, which can be a liquid-crystal display device or an organic light-emitting diode (OLED) display device. Wherein, if the display device in the embodiments of the disclosure is a liquid-crystal display device, the liquid-crystal display device includes a backlight module as a light supplier providing a sufficiently bright and uniform light source, and the backlight module in the present embodiments is of, but not limited to, backlight type or frontlight type.

The content is heretofore to further detail the disclosure with the preferred embodiments, but the embodiments of the disclosure is not construed as limited to the description. For those skilled in the art, any technical feature that can be obtained by simple logical analysis and inference, or replacement on the basis of the disclosure should be within the scope of the appended claims.

What is claimed is:

1. A manufacturing method of a display panel, wherein the display panel comprises a substrate, and the manufacturing method comprises steps of:
doping at least three kinds of dye molecules into a colloid used to manufacture a photoresist body;
applying the colloid on the substrate to form the photoresist body;
irradiating the photoresist body with at least three lights each having different wavelength to control the dye molecules, so as to form a color filter layer having at least three different colors under the radiation of the lights each having different wavelength;
wherein the photoresist body is irradiated with the light having the first-wavelength to control the dye molecules, so as to form a red filter under the radiation of the light having the first-wavelength;
wherein, the photoresist body is irradiated with the light having the second-wavelength to control the dye molecules so as to form a green filter under the radiation of the light having the second-wavelength; the photoresist body is irradiated with the light having the third-wavelength to control the dye molecules so as to form a blue filter under the radiation of the light having the third-wavelength; and
removing said photoresist body that does not become the color filter layer at the same time;
wherein, the step of irradiating the photoresist body with the light having the first-wavelength to control the dye molecules so as to form the red filter under the radiation of the first-wavelength light comprises: the light having the first-wavelength passing through a first mask and irradiating a red region of the photoresist body to control the dye molecules so as to form the red filter under the radiation of the light having the first-wavelength;
wherein, the step of irradiating the photoresist body with the light having the second-wavelength to control the dye molecules so as to form the green filter under the radiation of the light having the second-wavelength comprises: the light having the second-wavelength passing through a second mask and irradiating a green region of the photoresist body to control the dye molecules so as to form the green filter under the radiation of the light having the second-wavelength;
wherein, the step of irradiating the photoresist body with the light having the third-wavelength to control the dye molecules so as to form the green filter under the radiation of the light having the third-wavelength comprises: the light having the third-wavelength passing through a third mask and irradiation a blue region of the photoresist body to control the dye molecules so as to form the blue filter under the radiation of the light having the third-wavelength;
wherein, the color filter layer further comprises a W filter; the step of irradiating the photoresist body with at least three lights each having different wavelength to control the dye molecules so as to form the color filter layer having at least three different colors under the radiation of the lights each having different wavelengths further comprises: irradiating the photoresist body with a light having the fourth-wavelength to control the dye molecules so as to form a white filter under the radiation of the light having the fourth-wavelength;
wherein, the step of irradiating the photoresist body with the light having the fourth-wavelength to control the dye molecules so as to form the white filter under the radiation of the light having the fourth-wavelength further comprises: the light having the fourth-wavelength passing through a fourth mask and irradiating a white region of the photoresist body to control the dye molecules so as to form the white filter under the radiation of the light having the fourth-wavelength.

2. A manufacturing method of a display panel, wherein the display panel comprises a substrate, and the manufacturing method comprises steps of:
doping at least three kinds of dye molecules into a colloid used to manufacture a photoresist body;
applying the colloid on the substrate to form the photoresist body; and
irradiating the photoresist body with at least three lights each having different wavelength to control the dye molecules so as to form a color filter layer having at least three colors under the radiation of the lights each having different wavelength.

3. The manufacturing method of the display panel of claim 2, wherein after the step of irradiating the photoresist body with the lights each having different wavelength to control the dye molecules so as to form the color filter layer having at least three colors under the radiation of the lights each having different wavelength, the manufacturing method further comprises a step of:
removing the photoresist body that does not become the color filter layer at the same time.

4. The manufacturing method of the display panel of claim 2, wherein the step of irradiating the photoresist body with the at least three lights each having different wavelength to control the dye molecules so as to form the color filter layer having at least three colors under the radiation of the lights each having different wavelength comprises:
irradiating the photoresist body with the light having the first-wavelength to control the dye molecules so as to form a red filter under the radiation of the light having the first-wavelength;
irradiating the photoresist body with the light having the second-wavelength to control the dye molecules so as to form a green filter under the radiation of the light having the second-wavelength; and
irradiating the photoresist body with the light having the third-wavelength to control the dye molecules so as to form a blue filter under the radiation of the light having the third-wavelength.

5. The manufacturing method of the display panel of claim 4, wherein the step of irradiating the photoresist body with the light having the first-wavelength to control the dye molecules so as to form the red filter under the radiation of the light having the first-wavelength comprises:
the light having the first-wavelength passing through a first mask and irradiating a red region of the photoresist body to control the dye molecules so as to form the red filter under the radiation of the light having the first-wavelength.

6. The manufacturing method of the display panel of claim 2, wherein the step of irradiating the photoresist body with at least three lights each having different wavelength to control the dye molecules so as to form the color filter layer having at least three colors under the radiation of the lights each having different wavelength comprises:
irradiating the photoresist body with the light having the first-wavelength to control the dye molecules so as to form a red filter under the radiation of the light having the first-wavelength;
irradiating the photoresist body with the light having the second-wavelength to control the dye molecules so as to form a green filter under the radiation of the light having the second-wavelength; and
irradiating the photoresist body with the light having the third-wavelength to control the dye molecules so as to form a blue filter under the radiation of the light having the third-wavelength;
wherein, the step of irradiating the photoresist body with the light having the first-wavelength to control the dye molecules so as to form a red filter under the radiation of the light having the first-wavelength comprises: the light having the first-wavelength passing through a first mask and irradiating a red region of the photoresist to control the dye molecules so as to form the red filter under the radiation of the light having the first-wavelength.

7. The manufacturing method of the display panel of claim 4, wherein the step of irradiating the photoresist body with the light having the second-wavelength to control the dye molecules so as to form the green filter under the radiation of the light having the second-wavelength comprises:
the light having the second-wavelength passing through a second mask and irradiating a green region of the photoresist to control the dye molecules so as to form the green filter under the radiation of the light having the second-wavelength.

8. The manufacturing method of the display panel of claim 2, wherein the step of irradiating the photoresist body with at least three lights each having different wavelength to control the dye molecules so as to form the color filter layer having at least three colors under the radiation of the lights each having different wavelength comprises:
irradiating the photoresist body with the light having the first-wavelength to control the dye molecules so as to form a red filter under the radiation of the light having the first-wavelength;
irradiating the photoresist body with the light having the second-wavelength to control the dye molecules so as to form a green filter under the radiation of the light having the second-wavelength; and
irradiating the photoresist body with the light having the third-wavelength to control the dye molecules so as to form a blue filter under the radiation of the light having the third-wavelength;
wherein, the step of irradiating the photoresist body with the light having the second-wavelength to control the dye molecules so as to form the green filter under the radiation of the light having the second-wavelength comprises: the light having second-wavelength passing through a second mask and irradiating a green region of the photoresist to control the dye molecules so as to form the green filter under the radiation of the light having the second-wavelength.

9. The manufacturing method of the display panel of claim 4, wherein the step of irradiating the photoresist body with the light having the third-wavelength to control the dye molecules so as to form the blue filter under the radiation of the light having the third-wavelength comprises:
the light having the third-wavelength passing through a third mask and then irradiating a blue region of the photoresist to control the dye molecules so as to form the blue filter under the radiation of the light having the third-wavelength.

10. The manufacturing method of the display panel of the claim 2, wherein the step of irradiating the photoresist body with at least three lights each having different wavelength to control the dye molecules so as to form the color filter layer having at least three colors under the radiation of the lights each having different wavelength comprises:
irradiating the photoresist body with the light having the first-wavelength to control the dye molecules so as to form a red filter under the radiation of the light having the first-wavelength;
irradiating the photoresist body with the light having the second-wavelength to control the dye molecules so as to form a green filter under the radiation of the light having the second-wavelength; and
irradiating the photoresist body with the light having the third-wavelength to control the dye molecules so as to form a blue filter under the radiation of the light having the third-wavelength;
wherein, the step of irradiating the photoresist body with the light having the third-wavelength to control the dye molecules so as to form a blue filter under the radiation of the light having the third-wavelength comprises: the light having the third-wavelength passing through a third mask and irradiating a blue region of the photoresist to control the dye molecules so as to form the blue filter under the radiation of the light having the third-wavelength.

11. The manufacturing method of the display panel of claim 2, wherein the step of irradiating the photoresist body with at least three lights each having different wavelength to control the dye molecules so as to form the color filter layer having at least three colors under the radiation of the lights each having different wavelength comprises:
irradiating the photoresist body with the light having the first-wavelength to control the dye molecules so as to form a red filter under the radiation of the light having the first-wavelength;
irradiating the photoresist body with the light having the second-wavelength to control the dye molecules so as to form a green filter under the radiation of the light having the second-wavelength; and
irradiating the photoresist body with the light having the third-wavelength to control the dye molecules so as to form a blue filter under the radiation of the light having the third-wavelength;
wherein, the step of irradiating the photoresist body with the light having the first-wavelength to control the dye molecules so as to form the red filter under the radiation of the light having the first-wavelength comprises: the light having the first-wavelength passing through a first mask and irradiating a red region of the photoresist to control the dye molecules so as to form the red filter under the radiation of the light having the first-wavelength; the step of irradiating the photoresist body with the light having the second-wavelength to control the dye molecules so as to form the green filter under the radiation of the light having the second-wavelength comprises: the light having second-wavelength passing through a second mask and irradiating a green region of the photoresist to control the dye molecules so as to form the green filter under the radiation of the light having the second-wavelength; the step of irradiating the photoresist body with the light having the third-wavelength to control the dye molecules so as to form a blue filter under the radiation of the light having the third-wavelength comprises: the light having the third-wavelength passing through a third mask and irradiating a blue region of the photoresist to control the dye molecules so as to form the blue filter under the radiation of the light having the third-wavelength

12. The manufacturing method of the display panel of claim 2, wherein the color filter layer comprises a W filter.

13. The manufacturing method of the display panel of claim 12, wherein the step of irradiating the photoresist body with at least three lights each having different wavelength to control the dye molecules so as to form a color filter layer having at least three colors under the radiation of the lights each having different wavelength further comprises:
irradiating the photoresist body with a light having the fourth-wavelength to control the dye molecules so as to form a white filter under the radiation of the light having the fourth-wavelength.

14. The manufacturing method of the display panel of claim 2, wherein the color filter layer further comprises a W filter, and the step of irradiating the photoresist body with at least three lights each having different wavelength to control the dye molecules so as to form the color filter layer having at least three colors under the radiation of the lights each having different wavelength further comprises: irradiating the photoresist body with a light having the fourth-wavelength to control the dye molecules so as to form a white filter under the radiation of the light having the four-wavelength.

15. The manufacturing method of the display panel of claim 13, wherein the step of irradiating the photoresist body with the light having the fourth-wavelength to control the dye molecules so as to form the white filter under the radiation of the light having the fourth-wavelength further comprises:
the light having the fourth-wavelength passing through a fourth mask and irradiating a white region of the photoresist to control the dye molecules so as to form the white filter under the radiation of the light having the fourth-wavelength.

16. The manufacturing method of the display panel of claim 2, wherein the color filter layer further comprises a W filter, and the step of irradiating the photoresist body with at least three lights each having different wavelength to control the dye molecules so as to form the color filter layer having at least three colors under the radiation of the lights each having different wavelength further comprises: irradiating the photoresist body with a light having the fourth-wavelength to control the dye molecules so as to form a white filter under the radiation of the light having the four-wavelength, and the step of irradiating the photoresist body with the light having the fourth-wavelength to control the dye molecules so as to form a white filter under the radiation of the light having the four-wavelength further comprises: the light having the fourth-wavelength passing through a fourth mask and irradiating a white region of the photoresist to control the dye molecules so as to form the white filter under the radiation of the light having the fourth-wavelength.

17. The manufacturing method of the display panel of claim 2, wherein the step of irradiating the photoresist body with at least three lights each having different wavelength to control the dye molecules so as to form the color filter layer having at least three colors under the radiation of the lights each having different wavelength further comprises:
irradiating the photoresist body with the light having the first-wavelength to control the dye molecules so as to form a red filter under the radiation of the light having the first-wavelength;
irradiating the photoresist body with the light having the second-wavelength to control the dye molecules so as to form a green filter under the radiation of the light having the second-wavelength; and
irradiating the photoresist body with the light having the third-wavelength to control the dye molecules so as to form a blue filter under the radiation of the light having the third-wavelength;
wherein, the step of irradiating the photoresist body with the light having the first-wavelength to control the dye molecules so as to form the red filter under the radiation of the light having the first-wavelength comprises: the light having the first-wavelength passing through a first mask and irradiating a red region of the photoresist to control the dye molecules so as to form the red filter under the radiation of the light having the first-wavelength;
wherein, the step of irradiating the photoresist body with the light having the second-wavelength to control the dye molecules so as to form the green filter under the radiation of the light having the second-wavelength comprises: the light having second-wavelength passing through a second mask and irradiating a green region of the photoresist to control the dye molecules so as to form the green filter under the radiation of the light having the second-wavelength;
wherein, the step of irradiating the photoresist body with the light having the third-wavelength to control the dye molecules so as to form the blue filter under the radiation of the light having the third-wavelength comprises: the light having the third-wavelength passing through a third mask and irradiating a blue region of the photoresist to control the dye molecules so as to form the blue filter under the radiation of the light having the third-wavelength;
wherein, the color filter layer further comprises a W filter; the step of irradiating the photoresist body with at least three lights each having different wavelength to control said dye molecules so as to form the color filter layer having at least three different colors under the radiation of the lights each having different wavelengths further comprises: irradiating the photoresist body with a light having the fourth-wavelength to control the dye molecules so as to form a white filter under the radiation of the fourth-wavelength light;
wherein, the step of irradiating the photoresist body with the light having the fourth-wavelength to control the dye molecules so as to form the white filter under the radiation of the fourth-wavelength light further comprises: the light having the fourth-wavelength passing through a fourth mask and irradiating a white region of the photoresist to control the dye molecules so as to form the white filter under the radiation of the light having the fourth-wavelength.

18. A display panel, comprising:
a substrate; and
a color filter layer disposed on the substrate, wherein at least three different kinds of dye molecules that work in conjunction with at least three corresponding lights each having different wavelengths so as to form the color filter layer having at least three different colors are disposed in the color filter layer, and the color filter layer comprises a red filter, a green filter, and a blue filter.
